(19) United States
(12) Patent Application Publication
(10) Pub. No.: US 2006/0218044 A1
(43) Pub. Date: Sep. 28, 2006

(54) Method and apparatus for recording identities of selected items

(76) Inventors: Israel Gal, Warburg (IL); Shmuel Shalem, Beytar (IL)

Correspondence Address: TIAJOLOFF & KELLY, CHRYSLER BUILDING, 37TH FL, 405 LEXINGTON AVE, NEW YORK, NY, 10174, US

(21) Appl. No.: 10/550,789

(22) PCT Filed: Mar. 30, 2004
(86) PCT No.: PCT/IL04/00292

§ 371 Date: Sep. 27, 2005

(30) Foreign Application Priority Data
Mar. 31, 2003 (IL) 155176

(51) Int. Cl. G06Q 20/00

(52) U.S. Cl. 705/16

(57) ABSTRACT

Embodiments of the invention describe a device, system and method for selectively recording an entry corresponding to an identity of a selected item. Some exemplary embodiments of the invention include a portable selection device able to select data associated with identifiable items. The portable selection device may include a selection interface to enter at least one data entry identifying at least one of the items, and circuitry to enable recording of the at least one data entry. Other embodiments are described and claimed.

### BACKGROUND

At present, a visitor to a site displaying a large number of items, such as a museum or a trade show, who wishes to acquire a reproduction or other representation of one or more of the displayed items for later use or reference, or to obtain information or material relating to the items, may acquire a pre-produced article, for example, posters or a catalogue featuring a pre-defined collection of the displayed items.

### SUMMARY OF THE INVENTION

Embodiments of an aspect of the present invention provide a method or apparatus for providing a visitor to a site displaying items in an organized manner, for example, a museum, an archeological site, a trade show, or the like, with the ability to selectively record entries corresponding to the identity of selected items encountered at the site and, based on the recorded identities, to display and/or produce a media product featuring a reproduction or a representation of one or more of the items selected, or other information relating to at least one of the selected items.

In accordance with exemplary embodiments of the present invention, there may be provided a system including a selection device to selectively record entries corresponding to an identity of selected items, a processing station to retrieve and/or process information relating to the selected items, and an output device to produce a product related to the selected items.

In exemplary embodiments of the present invention, the selection device may include a portable device, e.g., hand-held device, having a selection interface to enter data identifying selected items. A memory in the device, for example, a Random-Access Memory (RAM), a FLASH memory, a portable hard disk or any other suitable memory device, may be used to record and/or store the identifying data entered by the user.

The selection interface may include a set of keys to enter the data identifying the selected entries. Optionally, the selection interface may include a display for displaying data entered by the user.

In some exemplary embodiments of the invention, the selection interface may include a code reader to read codes associated with predefined display items, whereby data may be entered into the selection device by reading the codes associated with selected items.

In some exemplary embodiments of the invention, the selection device may include a wireless transmission device to transmit selected data entries to a remote receiver, for example, to a receiver associated with the processing station, or to download stored data entries to the processing station. Alternatively, in some embodiments of the invention, the selected or stored data entries may be downloaded to the processing station device by a wire connection.

In some exemplary embodiments of the invention, the selection device may be incorporated as part of a Personal Digital Assistant (PDA), a cellular telephone or any other portable device including suitable hardware and/or software.

In exemplary embodiments of the present invention, the processing device may include any combination of hardware and/or software, e.g., a computer installed with suitable software, to allow retrieving and/or editing and/or otherwise processing information, e.g., pre-stored information, corresponding to the selected data entries received from the selection device.

In exemplary embodiments of the invention, the output device may include a printing device suitable for printing desired reproductions and/or other representations of items corresponding to selected data entries, for example, a customized catalogue of some or all of the items selected using the selection device.

In some exemplary embodiments of the invention, the output device may include suitable software and/or hardware to allow production of a media article, for example, an audio compact disc (CD-Audio) article, a video compact disc (CD-Video) article, a CD-ROM multimedia article, a personalized Web entry, an E-mail, for example, including appropriate links or attachments, or any other suitable media article corresponding to the selected data.

### BRIEF DESCRIPTION OF THE DRAWINGS

FIG. 1 is a schematic block diagram illustrating a system of selectively recording identities of selected items according to exemplary embodiments of the invention;

FIG. 2 is a schematic pictorial illustration of a portable selection device constructed and operative in accordance with exemplary embodiments of the present invention;

FIG. 3 is a functional block diagram illustration of the device of FIG. 2 in accordance with an embodiment of the present invention;

FIG. 4 is a schematic block diagram illustration of a processing station in accordance with an exemplary embodiment of the present invention;

FIG. 5 is a schematic block diagram illustrating the system of FIG. 1 further including an output device according to exemplary embodiments of the invention; and

FIG. 6 is a schematic flow chart illustrating a method of selectively recording identities of selected items in accordance with exemplary embodiments of the invention.

### DETAILED DESCRIPTION OF EMBODIMENTS OF THE INVENTION

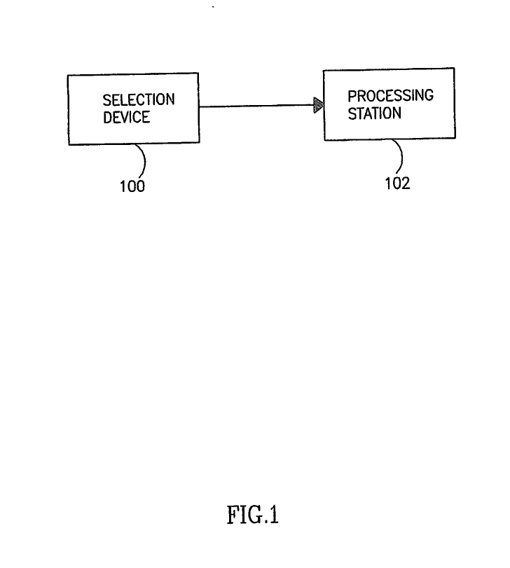

Reference is made to FIG. 1, which is a schematic block diagram illustrating a system of selectively recording identities of selected items according to exemplary embodiments of the invention. According to embodiments of the invention, a user may operate a selection device 100 as explained in detail below, to enter and record data associated with selected display items (not shown). The entered data may be adapted to identify the selected items, as described in detail below. In accordance with embodiments of the invention, the data entries may be recorded to be later downloaded to another device, for example, to a processing station 102, which is designed to receive the selected entries and to process data relating to the entries as described in detail below. Alternatively, the data entries may be directly transmitted from the selection device to processing station 102.

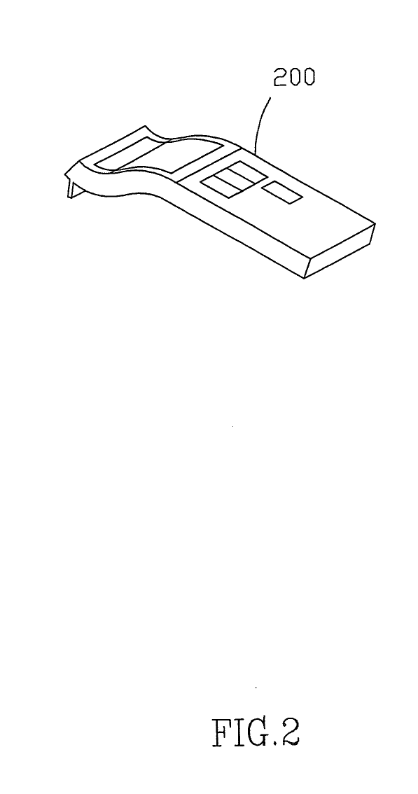

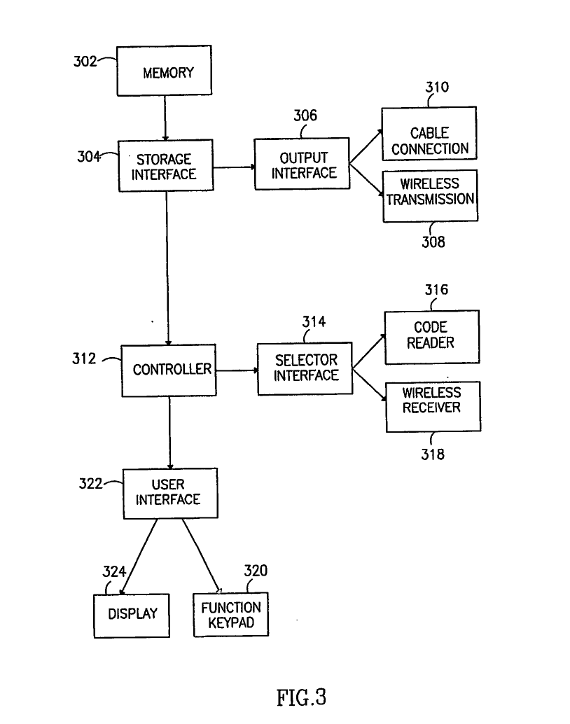

Reference is also made to FIG. 2, which is a schematic pictorial illustration of a portable selection device constructed and operative in accordance with exemplary embodiments of the present invention and to FIG. 3, which is a functional block diagram illustration of the device of FIG. 2 in accordance with exemplary embodiments of the present invention.

In exemplary embodiments of the invention, the selection device may include a hand-held housing 200 containing a memory 302, e.g., a FLASH memory, a solid state random-access memory (RAM), a portable hard disk, or any other suitable memory device. A storage interface circuitry 304 may be associated with memory 302 and with an output interface 306 having a port for transmition or download of data from selection device 100 to processing station 102, for example, via electronic and/or magnetic analog and/or digital means, and/or using wireless transmission 308. According to exemplary optional embodiments of the present invention, data corresponding to the selected entries may be transmitted from selection device 100 to processing station 102 by use of a wire connection from an output 310 of the selection device to an input of processing station 102.

The storage interface circuitry 304 may communicate with a controller 312. Controller 312 may communicate via a selector interface 314 with either or both of a code reader 316 and a wireless receiver 318 for receiving selection inputs.

The selection inputs may be provided directly by a user, using key inputs 320 or alternatively by any suitable selection input device. According to exemplary embodiments of the invention a code reader 316 such as a bar code reader may additionally or alternatively be used for entering data entries to selection device 100. Such a bar code reader may read codes located near an individual item, e.g., a picture, at a site displaying the items, for example, a museum, thus allowing the selection and/or the recording of the identity of the selected picture. Alternatively, a wireless receiver 318 may be used to receive signals from a transmitter associated with the selected item.

A user interface circuit 322 provides communication between controller 312 and a plurality of indicators and input devices, for example, a display 324 and a set of function keys 320. In some embodiments of the present invention, selection device 100 may include a wireless signal transmission circuit, for example, a RF or other electromagnetic transmitter, an infra-red transmitter, or any other suitable wireless transmitter, designed to allow wireless transmission of the data corresponding to the selected item from selection device 100 to processing station 102 substantially concurrently as it is entered by the user, thus eliminating or reducing the need for using memory circuit 302 in selection device 100. For example, in some embodiments, a low-capacity volatile memory or buffer may be sufficient to store information briefly pending transmission to station 102.

Additionally or alternatively, according to embodiments of the invention, selection device 100 may be integrated into a guiding device, such as the “exSite” device available from Espro Information Technologies Ltd., Israel, and/or in accordance with the devices described in U.S. Pat. No. 5,359,698 assigned to the assignee of the present application. In these embodiments, the guiding device may be provided with additional elements, e.g., additional keys, sensors and/or circuits, to perform the select-and-record functions described herein. Further, in these embodiments, the select-and-record functions of the present invention may be performed by the user while touring a site using the guiding device. Furthermore, selection device 100 may be integrated into any other suitable device, including but not limited to a Personal Digital Assistant (PDA) or a cellular phone including suitable hardware and/or software to perform the select-and-record functions described herein.

It will be understood by those of skill in the art that the schematic diagram of FIG. 3 represents the layout of only one embodiment of the invention, and that many other functional arrangements are possible in accordance with the invention.

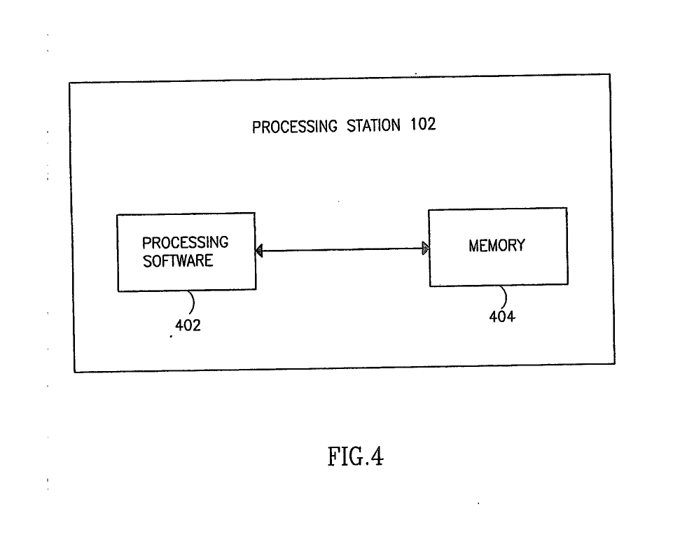

Reference is made also to FIG. 4, which is a schematic block diagram illustration of a processing station in accordance with an exemplary embodiment of the present invention. The processing station may include a digital computer unit having suitable processing software 402 to enable operations as described below, as well as a memory 404, for example, a database, for storing information related to items available for selection by the user. Memory 404 may further include a reference, e.g., a look-up-table, a set of pointers, or any other suitable device or means for correlating between the identities of items available for selection and the stored information relating to such items. The identities of the items may be represented in terms of the data entries received from selection device 100, in order to allow proper association of each entry to the corresponding selection and the stored information related thereto.

Processing software 404 may have access to the stored information relating to the items selectable by the user. An example of information that may be stored in a database of processing station 102 of a site displaying items, such as a museum, may include high-resolution reproductions of the items on display as well as other information relating to the items, for example, information about the artist and/or any other related items including non-selectable items or items not on display.

In some embodiments of the present invention, processing software 402 may further provide an option for editing the data corresponding to each selection. Processing software 402 may allow, for example, arrangement of a reproduction of the selected items; deleting one or more selections; adding further information in different media forms, including but not limited to video, audio, hyperlink or database; and changing the format of appearance, for example, changing background color, adding and removing titles and changing text font and size.

In an embodiment of an aspect of the present invention, processing software 402 may be adapted to produce specific types of catalogues, for example, a children's catalogue including special editing formats, such as illustration and background colors and/or any other desired information or feature in accordance with specific implementations and/or design requirements.

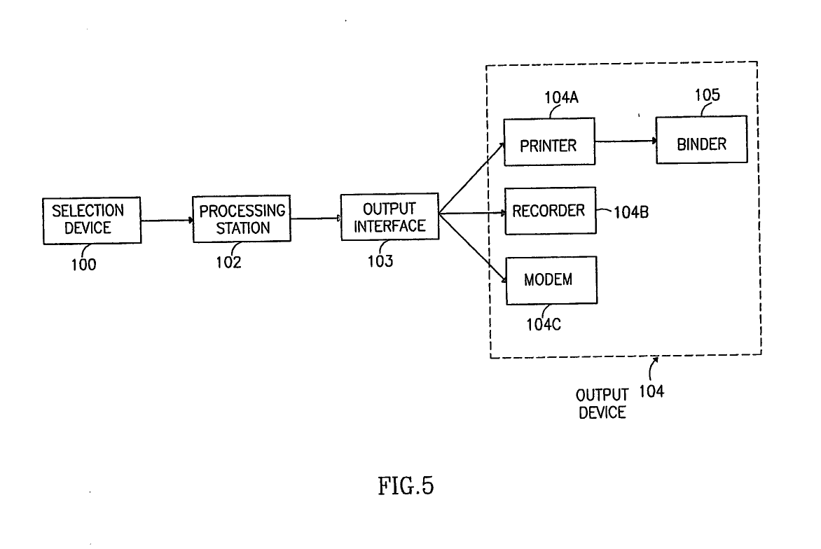

Reference is also made to FIG. 5 which is a schematic block diagram illustrating the system of FIG. 1 further including an output device according to exemplary embodiments of the invention.

In a further optional embodiment of the invention, processing station 102 may be associated via an output interface 103 with an output device 104 designed to produce an article in a desired media form, for example, a printed catalogue, a text file, a video and/or audio file, an e-mail, a link to a computer communication network site, e.g., a website, or a database or any other suitable media form. In one embodiment of the present invention, output device 104 may include a high-resolution printer 104A, which may optionally be associated with a suitable sorting/binding apparatus 105, for producing a printed catalogue such as a personal customized catalogue including, e.g., reproductions of the selected items, and/or data or information relating to some or all of the selected items. It should be noted that the printer 104A and binder 105 may be combined in one device. Additionally or alternatively, output device 104 may include a recording device 104B to produce a recording on a desired medium, e.g., a CD-ROM, including data corresponding to images, sounds and/or other information relating to the selected items. In some embodiments of the invention, output device 104 may include any suitable hardware and/or software, e.g., a modem and communication protocol software 104C, or any other Internet or network connection, as may be necessary in order to transmit information relating to the selected items, for example, via e-mail, or to be posted on a selected network site, e.g., an Internet site.

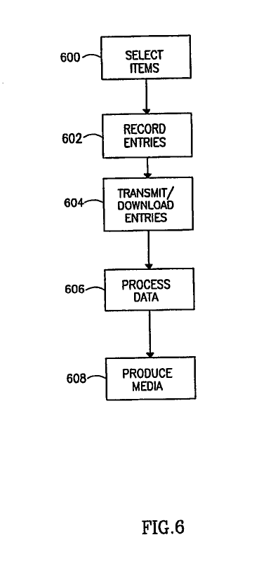

In some exemplary embodiments of the invention, output device 104 may include suitable software and/or hardware to allow production of a media article, for example, which may include a CD-Audio article, a CD-Video article, a CD-ROM multimedia article, a personalized Web entry, an E-mail including appropriate links and/or attachments, or any other required media article corresponding to the selected data. Reference is made also to FIG. 6, which is a flow chart describing a method for selectively recording identities of selected items in accordance with exemplary embodiments of the invention.

As indicated at block 600, the user using selection device 100 performs selection of one or more items.

As indicated at block 602, carried out subsequently after each selecting step 600, memory 302 of selection device 100 records the users entries for each selection.

In exemplary embodiments of the invention, output port 306 of selection device 100 downloads and/or transmits the recorded entries, as indicated at block 604, either manually by the user using an appropriate key on selection device 100, for example, at the end of the visit to the site, and/or automatically when selection device 100 is connected to processing station 102, and/or from time to time, e.g., upon establishing wireless communication between selection device 100 and processing station 102. As described above, in some embodiments of the invention block 602 is omitted and block 604, i.e., downloading or transmitting the data, is performed substantially concurrently with the selecting block 600.

As indicated at block 606, processing station 102 processes the data received from selection unit 100 at block 604.

According to optional embodiments of the invention, the data processed by processing station 102 at block 606, may further be transferred to production device 104 to further produce media corresponding to some or all of the data received, as indicated at block 608.

A system according to an embodiment of the present invention may include some or all of the features, devices and circuits discussed herein above. The features of the invention may be embodied in the form of separate units and/or in the form integrated units incorporating two or more features.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A portable selection device to select data associated with identifiable items comprising:
a selection interface to enter at least one data entry identifying at least one of said items; and
circuitry to enable recording of said at least one data entry.

2. A portable device according to claim 1 further comprising a memory associated with said circuitry to store said at least one data entry.

3. A portable device according to claim 1 further comprising an output port to transfer said at least one entry to a processing station adapted to process information related thereto.

4. The device according to claim 3, wherein said circuitry comprises a wire connection to connect said device to said processing station.

5. The device according to claim 1, further comprising a hand held enclosure accommodating said selection interface and said circuitry.

6. The device according to claim 1, wherein said selection interface comprises a keypad.

7. The device according to claim 1, wherein said selection interface comprises a code reader apparatus.

8. The device according to claim 1, wherein said circuitry comprises a wireless transmitter.

9. A system comprising:
a selection device comprising a selection interface to enter at least one data entry identifying at least one identifiable item and circuitry to provide an output corresponding to said at least one data entry; and
a processing station adapted to receive said at least one data entry and to process information related thereto.

10. A system according to claim 9, wherein said selection device further comprises a memory to store said at least one data entry.

11. The system according to claim 9, further comprising an output device associated with said processing station to produce an article relating to said at least one item.

12. The system according to claim 11, wherein said output device comprises a printer to print an image relating to said at least one item.

13. The system according to claim 11, wherein said output device comprises a recording device to record information relating to said at least one item.

14. The system of claim 11, wherein said circuitry comprises a wire connection to connect said device to said processing station.

15. The system of claim 11, wherein said article comprises a digital video article.

16. The system of claim 11, wherein said article comprises an audio article.

17. The system of claim 11, wherein said article comprises a personalized site of a computer communication network.

18. The system of claim 9, wherein said selection device comprises a hand held enclosure accommodating said selection interface and said circuitry.

19. The system of claim 9, wherein said selection interface comprises a keypad.

20. The system of claim 9, wherein said selection interface comprises a code reader apparatus.

21. The system of claim 9, wherein said circuitry comprises a wireless transmitter.

22. A method comprising:
receiving at least one data entry identifying at least one item selected by a user;
transferring the data entry to a processing device able to access information related to said at least one data entry; and
retrieving said information.

23. The method of claim 22 further comprising:
producing an article based on said information.

24. A portable device according to claim 2 further comprising an output port to transfer said at least one entry to a processing station adapted to process information related thereto.

25. The system according to claim 10, further comprising an output device associated with said processing station to produce an article relating to said at least one item.

26. The system according to claim 25, wherein said output device comprises a recording device to record information relating to said at least one item.

27. The system according to claim 12, wherein said output device comprises a recording device to record information relating to said at least one item.
